(19) United States
(12) Patent Application Publication
(10) Pub. No.: US 2016/0209343 A1
(43) Pub. Date: Jul. 21, 2016

(54) THERMAL LOAD TESTING DEVICE AND THERMAL LOAD TESTING METHOD

(71) Applicant: Mitsubishi Hitachi Power Systems, Ltd., Kanagawa-ken (JP)

(72) Inventors: Yoshifumi OKAJIMA, Tokyo (JP); Taiji TORIGOE, Tokyo (JP); Takayuki KURIMURA, Tokyo (JP); Hitoshi TAMAKI, Tokyo (JP); Daigo WATANABE, Tokyo (JP); Masamitsu KUWABARA, Yokohama-shi (JP); Masaaki MATSUURA, Hiroshima-shi (JP)

(21) Appl. No.: 14/994,312

(22) Filed: Jan. 13, 2016

(30) Foreign Application Priority Data
Jan. 21, 2015 (JP) 2015-009351

(51) Int. Cl. G01N 25/72

(52) U.S. Cl. CPC G01N 25/72

(57) ABSTRACT

The thermal load testing device of the present invention makes it possible to produce a large temperature differential between a surface and an interior of a test piece while applying a load to the test piece. A thermal load testing device (1) includes a load applying portion (2) that applies a load to a tubular test piece (10) in an axial line (O) direction, the tubular test piece (10) having a hollow portion (11) that extends along the axial line (O); a cooling fluid supplying portion (3) that causes a cooling fluid to flow through the hollow portion (11); and an infrared image furnace (4) that heats the test piece (10) by a plurality of infrared sources (42) disposed so as to surround the test piece (10) from a whole region in a circumferential direction.

### TECHNICAL FIELD

The present invention relates to a thermal load testing device and a thermal load testing method.

### BACKGROUND ART

In order to improve the efficiency of a gas turbine, the temperature of the gas to be used is set high. The surfaces of turbine members, such as a blade and a vane, exposed to such a high-temperature gas are coated with a thermal barrier coating (TBC). TBC is a coating obtained by applying a thermal spray material having a small coefficient of thermal conductivity (such as a ceramic-based material having a small coefficient of thermal conductivity) by thermal spraying onto the surfaces of the turbine members, which are the objects to be sprayed. Such a coating improves the heat shielding property and durability of the turbine members.

Turbine members exposed to a high-temperature gas are susceptible to thermal stress resulting from a temperature differential between the TBC surface and the turbine member surface, as well as large superimposed loads such as that of a centrifugal force, which cause the TBC to peel. To ensure the reliability of the turbine members, a TBC peeling evaluation needs to be conducted. Examples of peeling evaluation methods include simulating a turbine member exposed to a high-temperature gas by heating the surface of a TBC-coated test piece while applying a load to the test piece. In such a method, a device that heats the test piece while applying a load is used.

Examples of such devices that heat a test piece while applying a load include a stress observation device disclosed in Patent Literature 1. The stress observation device disclosed in Patent Literature 1 applies tensile or compressive stress to a test material serving as the test piece while heating the test material using a heater inside an infrared image furnace provided with a window that allows observation from the outside. This stress observation device makes it possible to observe the test material while applying stress to the test material under a high-temperature environment.

### CITATION LIST

### Patent Literature

Patent Literature 1: Japanese Unexamined Patent Application Publication No. 2001-165879A

### SUMMARY OF THE INVENTION

### Technical Problem

However, with a TBC-coated turbine member, a large temperature differential of several hundred degrees occurs between the TBC surface and the turbine member interior due to the heat-shielding effect of the TBC. Nevertheless, it is difficult to produce a large temperature differential of several hundred degrees between the surface and the interior of the test piece by heating the surface of the test piece alone, as in the stress observation device described in Patent Literature 1. Such difficulties have led to a demand for implementing an evaluation test that produces a large temperature differential between the surface and the interior of the test piece.

The present invention has been made to resolve the demand described above, and thus an object of the present invention is to provide a thermal load testing device and a thermal load testing method capable of producing a large temperature differential between a surface and an interior of a test piece while applying a load to the test piece.

### Solution to Problem

In order to solve the above-described problem, the present invention proposes the following means.

A thermal load testing device according to a first aspect of the present invention includes a load applying portion that applies a load to a tubular test piece in an axial line direction, the tubular test piece having a hollow portion that extends along the axial line; a cooling fluid supplying portion that causes a cooling fluid to flow through the hollow portion; and an infrared image furnace that heats the test piece by a plurality of infrared sources disposed so as to surround the test piece from a whole region in a circumferential direction.

According to such a configuration, it is possible to cause the cooling fluid to flow from the cooling fluid supplying portion through the hollow portion, and heat the test piece from the whole region in the circumferential direction using the infrared image furnace. This makes it possible to heat the surface of the test piece with the interior of the test piece having been cooled, and produce a large temperature differential between the surface and the interior of the test piece. Then, by applying a load in the axial line direction using the load applying portion while producing the large temperature differential, it is possible to superimpose a load with a large heat flux produced on the test piece.

Further, the thermal load testing device may further include a temperature measuring portion that measures temperatures of the test piece, and a controller that adjusts and controls an amount of heat applied to the test piece by the infrared image furnace.

According to such a configuration, the amount of heat applied to the test piece is adjusted and controlled on the basis of measurement results of the temperatures of the test piece measured by the temperature measuring portion, thereby making it possible to heat the test piece in accordance with a temperature condition of the test piece. This suppresses the implementation of a test in which a load is applied to the test piece having an unintended temperature condition, such as only the surface of the test piece being heated and the interior of the test piece being inadequately heated, which makes it possible to efficiently implement a test.

Further, in the thermal load testing device, the controller may synchronize a change rate of the amount of heat applied by the infrared image furnace and a change rate of the load applied by the load applying portion on the basis of the measurement results from the temperature measuring portion.

According to such a configuration, it is possible to synchronize and adjust the change rate of the amount of heat and the change rate of the load in accordance with a temperature condition of the test piece using a synchronizing portion. This makes it possible to superimpose an intended load while adjusting the temperature condition of the test piece with high accuracy. As a result, the test can be implemented more efficiently.

Further, a thermal load testing method according to a second aspect of the present invention includes a load applying step of applying a load to a tubular test piece in an axial line direction, the tubular test piece having a hollow portion that extends along the axial line; a cooling fluid supplying step of causing a cooling fluid to flow through the hollow portion, the cooling fluid supplying step being implemented along with the load applying step; and an infrared heating step of heating the test piece by a plurality of infrared sources disposed so as to surround the test piece from a whole region in a circumferential direction using an infrared image furnace, the infrared heating step being implemented along with the cooling fluid supplying step.

According to such a configuration, it is possible to cause the cooling fluid to flow through the hollow portion in the cooling fluid supplying step, and heat the test piece from the whole region in the circumferential direction in the infrared heating step. This makes it possible to heat the surface of the test piece with the interior of the test piece cooled, and produce a large temperature differential between the surface and the interior of the test piece. Then, by applying a load in the axial line direction in the load applying step while producing the large temperature differential, it is possible to superimpose a load with a large heat flux produced on the test piece.

Further, the thermal load testing method may further include a temperature measuring step of measuring temperatures of the test piece, and a synchronizing step of synchronizing a change rate of an amount of heat applied to the test piece and a change rate of a load applied to the test piece on the basis of the temperatures of the test piece measured in the temperature measuring step.

According to such a configuration, it is possible to synchronize and adjust the change rate of the amount of heat and the change rate of the load in accordance with a temperature condition of the test piece in a synchronizing step. This makes it possible to superimpose an intended load while adjusting the temperature condition of the test piece with high accuracy. As a result, the test can be implemented more efficiently.

### Advantageous Effects of Invention

According to the thermal load testing device and the thermal load testing method of the present invention, it possible to produce a large temperature differential between a surface and an interior of a test piece while applying a load to the test piece by heating the test piece by an infrared image furnace while causing a cooling fluid to flow through a hollow portion.

### BRIEF DESCRIPTION OF DRAWING

FIG. 1 is a schematic view illustrating an outline of a thermal load testing device of an embodiment of the present invention.

FIG. 2 is a cross-sectional view illustrating an outline of an infrared image furnace of the embodiment of the present invention.

FIG. 3 is a schematic view illustrating an outer appearance of the infrared image furnace of the embodiment of the present invention.

FIGS. 4A to 4C are graphs showing relationships between a temperature of a test piece, an output of infrared lamps, a load applied by a load applying portion, and time in the embodiment of the present invention. FIG. 4A is a graph showing a change rate of the temperature of the test piece, FIG. 4B is a graph showing a change rate of the output of the infrared lamps, and FIG. 4C is a graph showing a change rate of the load applied by the load applying portion.

FIG. 5 is a flowchart illustrating a thermal load testing method of the embodiment of the present invention.

### DESCRIPTION OF EMBODIMENTS

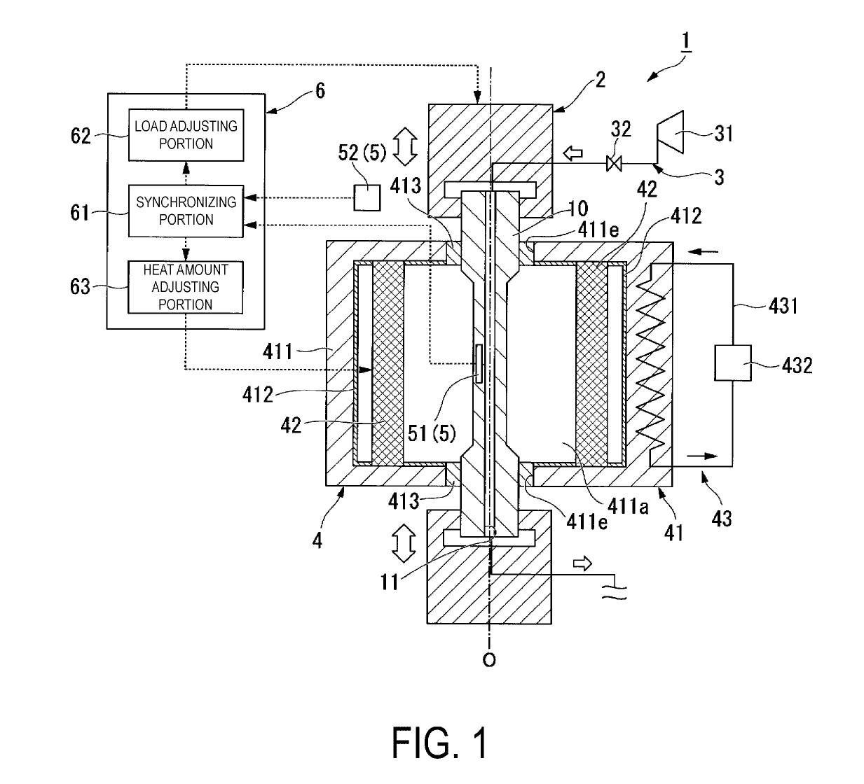

An embodiment according to the present invention is described below with reference to FIGS. 1 to 5.

A thermal load testing device 1 applies a load to a test piece 10 while cooling an interior and heating a surface thereof, thereby superimposing a load onto the test piece 10 while producing a high heat flux between the surface and the interior. In the thermal load testing device 1, the tubular test piece 10 having a hollow portion 11 that extends along an axial line O is used. The thermal load testing device 1 of the present embodiment, as illustrated in FIG. 1, includes a load applying portion 2 that applies a load to the test piece 10 in the axial line O direction, a cooling fluid supplying portion 3 that causes a cooling fluid to flow through the hollow portion 11, an infrared image furnace 4 that heats the test piece 10 by infrared lamps (infrared sources) 42, a temperature measuring portion 5 that measures a temperature of the test piece 10, and a controller 6 that adjusts and controls the amount of heat applied to the test piece on the basis of measurement results from the temperature measuring portion 5.

The test piece 10 used in the present embodiment is a rod-shaped member that includes therein the hollow portion 11 formed as a through-hole. In the test piece 10, the hollow portion 11, which has a circular cross section, extends in the axial line O direction through a center of a cross section orthogonal to the axial line O. The test piece 10 has a circular cross section in which both end sections have large outer diameters compared to a center section in the axial line O direction. The center section in the axial line O direction of the test piece 10 is a section that deforms when load is applied, and is uniformly heated by the infrared lamps 42. Both end sections of the test piece 10 are supported by the load applying portion 2. In the present embodiment, for example, the center section of the test piece 10 is formed so as to have a length that is about one-fifth of a total length of the test piece 10. The surface of the test piece 10 is coated with TBC of a predetermined thickness. The thickness of the TBC applied to the test piece 10 in the present embodiment is set to a desired thickness in accordance with conditions of the TBC to be evaluated.

The load applying portion 2 holds both end sections of the test piece 10 on an outer side of the infrared image furnace 4.

The load applying portion 2 applies a displacement load in the axial line O direction in accordance with predetermined test conditions. The test conditions applied to the load applying portion 2 of the present embodiment include setting a change rate until a predetermined load is reached to a value determined in advance, and applying a load to the test piece 10 at a constant rate of increase. The load applying portion 2, which is a hydraulic servo, repeatedly applies a load to the test piece 10 in the axial line O direction.

The cooling fluid supplying portion 3 is connected to the hollow portion 11 at both end portions of the test piece 10, and supplies the cooling fluid. The cooling fluid supplying portion 3 of the present embodiment includes a compressor 31, and supplies compressed air, as cooling fluid, having a temperature lower than the temperature of the heat applied by the infrared image furnace 4. The cooling fluid supplying portion 3 includes a valve portion 32 that adjusts the supply of the compressed air to the hollow portion 11. The cooling fluid supplying portion 3 starts supplying compressed air to the hollow portion 11 by the valve portion 32 being opened, and stops supplying compressed air to the hollow portion 11 by the valve portion 32 being closed. The compressed air supplied from the cooling fluid supplying portion 3 is supplied from an upper end of the test piece 10, the upper end being one end portion in the axial line O direction. The compressed air is then caused to flow through the hollow portion 11, and is discharged to a discharge port (not illustrated) from a lower end of the test piece 10, the lower end being the other end in the axial line O direction.

The infrared image furnace 4 heats the test piece 10 across an entire circumference thereof by emitting infrared rays from the plurality of infrared lamps 42 disposed so as to surround the test piece 10 from a whole region in the circumferential direction. The infrared image furnace 4 heats the test piece 10 in accordance with predetermined heating conditions. The heating conditions applied to the infrared image furnace 4 of the present embodiment include setting a change rate of an amount of heat from the infrared lamps 42 until a predetermined temperature is reached to a value determined in advance, and applying heat to the test piece 10 at a constant rate of increase. That is, the infrared image furnace 4 heats the test piece 10 at a constant heating rate per unit time up to a predetermined temperature. The infrared image furnace 4 of the present embodiment includes an image furnace main body 41, the plurality of infrared lamps 42 disposed inside the image furnace main body 41, and a furnace cooling portion 43 that cools the infrared lamps 42.

The image furnace main body 41 includes a main portion 411 having a closed interior space 411a capable of housing therein the infrared lamps 42, a reflecting portion 412 attached to the inner surface of the main portion 411, and sealing portions 413 that seal gaps between the test piece 10 and the main portion 411.

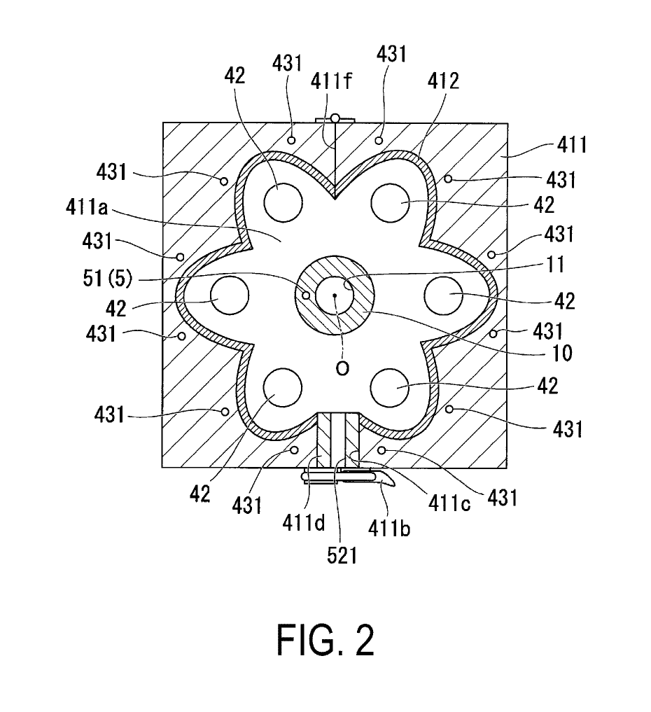

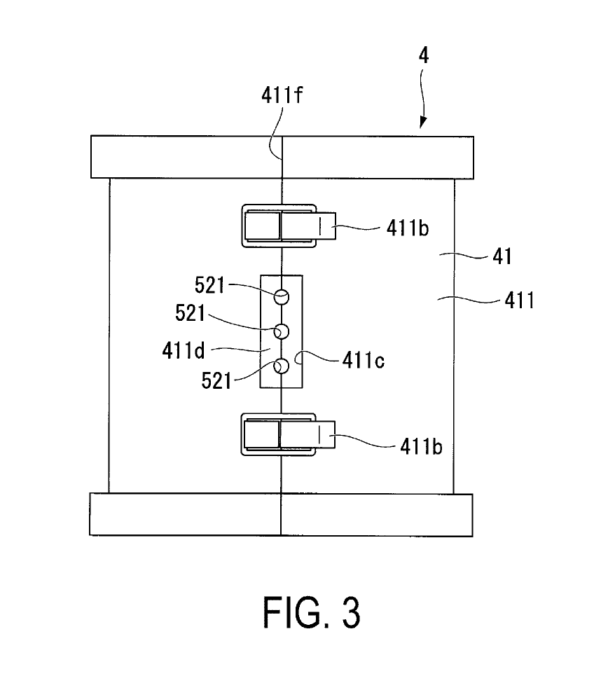

The main portion 411 is formed into a rectangular box shape that includes therein the interior space 411a. The main portion 411 allows the test piece 10 to be disposed in a center of the interior space 411a in a cross section orthogonal to the axial line O direction. In the main portion 411, the plurality of infrared lamps 42 are disposed in the interior space 411a so as to surround the test piece 10. In the main portion 411, insertion holes 411e through which the test piece 10 is inserted are formed on opposing surfaces so that both end portions of the test piece 10 appear outside. The main portion 411 can be divided into two by a dividing surface 411f parallel to the axial line O direction. The main portion 411, as illustrated in FIG. 3, includes externally provided lock portions 411b for integrally fixing the main portion 411. The main portion 411, as illustrated in FIG. 2, includes an observation opening portion 411c disposed across the dividing surface 411f. This observation opening portion 411c allows verification of the interior space 411a from outside the main portion 411. The main portion 411 includes a cover portion 411d that covers the observation opening portion 411c.

The interior space 411a of the main portion 411 has a curved surface shape for gathering the infrared rays emitted from the infrared lamps 42 toward the center. Specifically, the interior space 411a, as illustrated in FIG. 2, has a cross section orthogonal to the axial line O direction that is formed into a shape in which one focal point of each of a plurality of ellipses or parabolas is made to overlap and serve as the center, and other focal points of the plurality of ellipses or parabolas corresponding to the number of disposed infrared lamps 42 are equally spaced apart in the circumferential direction. That is, in the interior space 411a, one focal point of the ellipses or parabolas serves as the center, and the other focal points are spaced apart in the circumferential direction, resulting in the formation of flower petal-like shapes. In the interior space 411a of the present embodiment, six ellipses are overlapped.

The observation opening portion 411c extends in the main portion 411 from the outside to the interior space 411a in a direction orthogonal to the axial line O direction so as to allow verification of the center section of the test piece 10 when the test piece 10 is inserted through the insertion holes 411e. The observation opening portion 411c of the present embodiment is an open hole that is formed into a rectangular shape.

The cover portion 411d is a block-shaped member that covers the observation opening portion 411c. The cover portion 411d fits into the observation opening portion 411 to seal the interior space 411a.

The reflecting portion 412 reflects the infrared rays emitted from the infrared lamps 42 in the circumferential direction so that the rays converge toward the test piece 10. The reflecting portion 412 covers the inner surface of the interior space 411a and the inner surface of the cover portion 411d. The reflecting portion 412 of the present embodiment is formed by surface treating the inner surface of the interior space 411a and the surface on the inside of the cover portion 411d so that the surfaces are capable of reflecting infrared rays. The reflecting portion 412 is given mirror-like finishes by a gold plating process or the like.

The sealing portions 413 are provided to the insertion holes 411e. The sealing portions 413 are provided so as to slidably contact the test piece 10 inserted through the insertion holes 411e. With the test piece 10 inserted through the insertion holes 411e, the sealing portions 413 seal the gaps between the test piece 10 and the insertion holes 411e to seal the interior space 411a.

The infrared lamps 42 emit infrared rays to heat the test piece 10. The infrared lamps 42 each extend in the axial line O direction, and both end portions thereof are fixed to the inner side of the main portion 411. The infrared lamps 42 of the present embodiment allow the change rate of the amount of heat applied to the test piece 10 to be adjusted by changing a power supplied to the infrared lamps 42 on the basis of a signal transmitted from the controller 6. The infrared lamps 42 are formed into a cylindrical shape. The infrared lamps 42 are disposed so as to surround the test piece 10 disposed in the center, which is one focal point of the ellipses or parabolas of the interior space 411a, the infrared lamps 42 being spaced apart at the other focal points of the ellipses and parabolas. The infrared lamps 42, as described above, are provided at six locations in the interior space 411a, equally spaced apart in the circumferential direction with respect to the test piece 10.

The furnace cooling portion 43 cools the plurality of the infrared lamps 42. The furnace cooling portion 43 of the present embodiment includes a plurality of circulation pipe portions 431 embedded in the main portion 411, and a circulating portion 432 that circulates the cooling fluid through the circulation pipe portions 431.

The circulation pipe portions 431 are tubes through which the cooling fluid flows. The circulation pipe portions 431 are embedded correspondingly with the infrared lamps 42 in the main portion 411. The circulation pipe portions 431 of the present embodiment are embedded at two locations in the main portion 411 per infrared lamp 42 so as to sandwich the infrared lamp 42. The circulation pipe portion 431 is provided at 12 locations in total.

The circulating portion 432 cools the cooling fluid used to cool the infrared lamps 42, and circulates the cooling fluid through the circulation pipe portions 431. The circulating portion 432 of the present embodiment cools the cooling fluid warmed by the infrared lamps 42 by exchanging heat with a secondary cooling water different from the cooling fluid.

The temperature measuring portion 5 measures the temperature state of the test piece 10 heated by the infrared image furnace 4. The temperature measuring portion 5 of the present embodiment includes an internal measuring portion 51 that is embedded in the test piece 10 and measures the temperature of the interior of the test piece 10, and an external measuring portion 52 that measures the temperature of the surface of the test piece 10 from outside the test piece 10.

The internal measuring portion 51, as illustrated in FIG. 1, is embedded in the center section of the test piece 10, and measures the internal temperature of the test piece 10. The internal measuring portion 51 transmits the internal temperature data of the test piece 10 to the controller 6. This internal temperature data is the measured measurement result. Examples of the internal measuring portion 51 of the present embodiment include a thermocouple.

The external measuring portion 52 measures the surface temperature of the test piece 10 in a non-contact manner via monitoring holes 521 provided in the cover portion 411d, as illustrated in FIGS. 2 and 3. The external measuring portion 52 transmits the surface temperature data of the test piece 10 to the controller 6. This surface temperature data is the measured measurement result. Examples of the external measuring portion 52 of the present embodiment include a two-color thermometer.

The controller 6 transmits an instruction to the infrared image furnace 4 so as to adjust the change rate of the amount of heat applied to the test piece 10, and transmits another instruction to the load applying portion 2 so as to adjust the change rate of the load applied to the test piece 10, on the basis of the measurement results measured by the temperature measuring portion 5. The controller 6, as illustrated in FIG. 1, includes a synchronizing portion 61 that receives the measurement results from the temperature measuring portion 5, a load adjusting portion 62 that adjusts and controls the load applied by the load applying portion 2 on the basis of an input from the synchronizing portion 61, and a heat amount adjusting portion 63 that adjusts and controls the amount of heat applied by the infrared image furnace 4 on the basis of an input from the synchronizing portion 61.

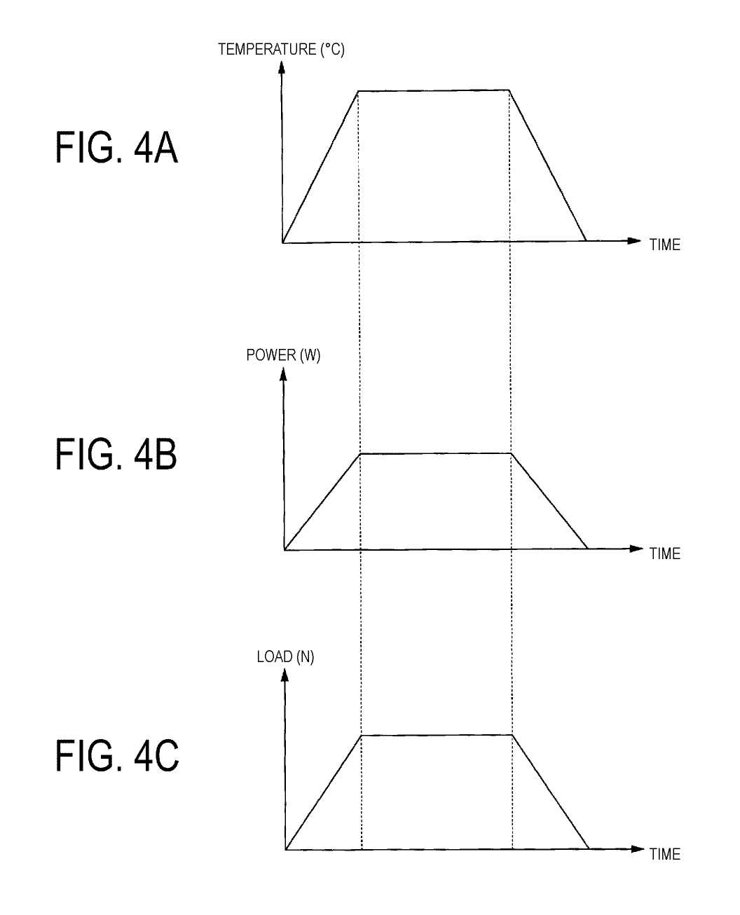

The synchronizing portion 61 outputs signals to the load adjusting portion 62 and the heat amount adjusting portion 63 so as to synchronize the change rate of the amount of heat applied by the infrared image furnace 4 and the change rate of the load applied by the load applying portion 2. The synchronizing portion 61 of the present embodiment receives the internal temperature data transmitted from the internal measuring portion 51 and the surface temperature data transmitted from the external measuring portion 52. The synchronizing portion 61 calculates a temperature differential between the interior and the surface of the test piece 10 from the difference between the internal temperature data and the surface temperature data to obtain the temperature state of the test piece 10. The synchronizing portion 61 outputs a signal for adjusting the change rate of the amount of heat applied by the infrared image furnace 4 to the heat amount adjusting portion 63 so that the calculated temperature state of the test piece 10 matches the predetermined heating conditions of the test piece 10 imposed on the infrared image furnace 4, such as those illustrated in FIG. 4A. Along with outputting the signal to the heat amount adjusting portion 63, the synchronizing portion 61 outputs a signal to the load adjusting portion 62 so as to synchronize the adjusted change rate of the amount of heat applied by the infrared image furnace 4 and the change rate of the load applied by the load applying portion 2.

The heat amount adjusting portion 63 transmits instructions to the infrared lamps 42 so as to fluctuate the change rate of the amount of heat applied to the test piece 10 on the basis of the signal received from the synchronizing portion 61. The heat amount adjusting portion 63 transmits the instructions to each of the plurality of infrared lamps 42. The heat amount adjusting portion 63 of the present embodiment adjusts the power supplied to the infrared lamps 42 as illustrated in FIG. 4B so that the temperature state of the test piece 10 matches the heating conditions such as those illustrated in FIG. 4A.

The load amount adjusting portion 62 transmits an instruction to the load applying portion 2 so as to fluctuate the change rate of the load applied to the test piece 10 on the basis of the signal received from the synchronizing portion 61. The load adjusting portion 62 of the present embodiment adjusts the amount of load applied to the test piece 10 by the load applying portion 2 as illustrated in FIG. 4C so as to match transitions in the power supplied to the infrared lamps 42, such as those illustrated in FIG. 4B.

Next, a thermal load testing method S1 of the above-described embodiment will be described.

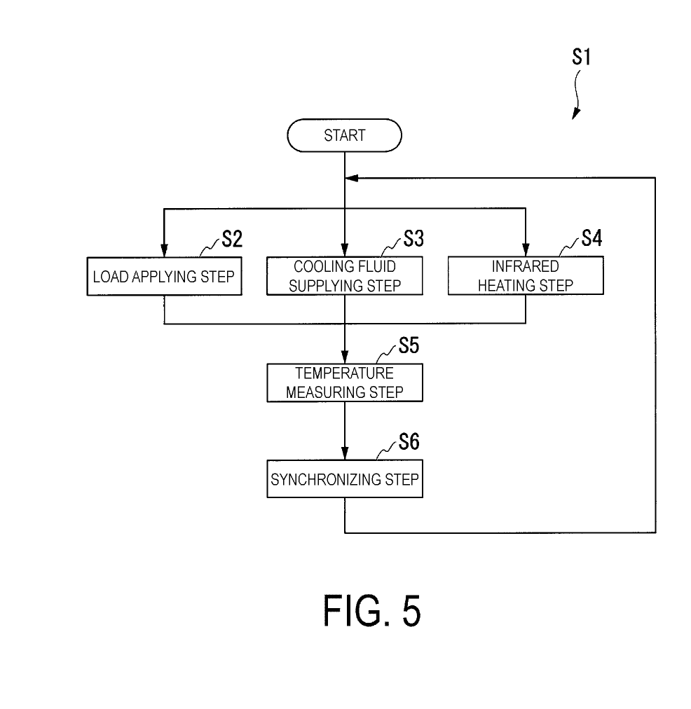

The thermal load testing method S1 applies a load to the test piece 10 while cooling the interior and heating the surface thereof, thereby superimposing a load onto the test piece 10 while producing a high heat flux. The thermal load testing method S1 of the present embodiment is implemented as a heat cycle test that uses the thermal load testing device 1. The thermal load testing method S1, as illustrated in FIG. 5, includes a load applying step S2 of applying a load in the axial line O direction to the test piece 10 having the hollow portion 11, a cooling fluid supplying step S3 of causing a cooling fluid to flow through the hollow portion 11, an infrared heating step S4 of heating the test piece 10 with the infrared lamps 42, a temperature measuring step S5 of measuring a temperature of the test piece 10, and a synchronizing step S6 of synchronizing the change rate of the amount of heat applied to the test piece 10 and the change rate of the load applied to the test piece 10 on the basis of measurement results in the temperature measuring step S5.

The load applying step S2 applies a load to the test piece 10 in the axial line O direction with the load applying portion 2. The load applying step S2 of the present embodiment sets the change rate until a predetermined load is reached to a predetermined value and applies a load to the test piece at a constant rate of increase in accordance with test conditions, such as those illustrated in FIG. 4C.

The cooling fluid supplying step S3 is performed along with the load applying step S2. In the cooling fluid supplying step S3 of the present embodiment, compressed air is supplied as a cooling fluid to the hollow portion 11 with the cooling fluid supplying portion.

The infrared heating step S4 is performed along with the load applying step S2 and the cooling fluid supplying step S3. In the infrared heating step S4 of the present embodiment, the test piece 10 is heated across an entire circumference thereof by the plurality of infrared lamps 42 disposed so as to surround the test piece 10 from the whole region in the circumferential direction, using the infrared image furnace 4. In the infrared heating step S4, the change rate of the amount of heat applied by the infrared lamps 42 until a predetermined temperature is reached to a value determined in advance and heats the test piece 10 at a constant rate of increase in accordance with heating conditions, such as those illustrated in FIG. 4A.

In the temperature measuring step S5, the temperature of the heated test piece 10 is measured. In the temperature measuring step S5 of the present embodiment, the temperature of the interior and the temperature of the surface of the test piece 10 are measured. In the temperature measuring step S5, the internal temperature data of the test piece 10 measured by the internal measuring portion 51 and the surface temperature data of the test piece 10 measured by the external measuring portion 52 are acquired.

In the synchronizing step S6, the change rate of the load applied to the test piece 10 in the load applying step S2 and the change rate of the amount of heat applied to the test piece 10 in the infrared heating step S4 are synchronized on the basis of the temperature of the interior and the temperature of the surface of the test piece 10 measured and acquired in the temperature measuring step S5. The synchronizing step S6 of the present embodiment is performed by the controller 6. Specifically, in the synchronizing step S6 of the present embodiment, the synchronizing portion 61 of the controller 6 that has received the internal temperature data and the surface temperature data calculates the temperature differential between the interior and the surface of the test piece 10 from the difference between the internal temperature data and the surface temperature data to estimate the temperature state of the test piece 10. In the synchronizing step S6, the change rate of the amount of heat applied to the test piece 10 in the infrared heating step S4 is adjusted so that the measured temperature state of the test piece 10 matches the predetermined heating conditions imposed on the infrared image furnace 4, such as those illustrated in FIG. 4A. Along with adjusting the amount of heat in the infrared heating step S4, in the synchronizing step S6, the adjusted change rate of the amount of heat in the infrared heating step S4 and the change rate of the load in the load applying step S2 are synchronized. It should be noted that in the synchronizing step S6 of the present embodiment, the supply conditions of the compressed air supplied to the hollow portion 11 in the cooling fluid supplying step S3 are not changed.

As a result, in the thermal load testing method S1 of the present embodiment, the temperature measuring step S5 and the synchronizing step S6 are performed while simultaneously performing the load applying step S2, the cooling fluid supplying step S3, and the infrared heating step S4. That is, in the thermal load testing method S1, while a load is applied to the test piece 10, which includes the hollow portion 11 through which compressed air flows, the load and the amount of heat are adjusted in the synchronizing step S6 in accordance with the temperature condition of the test piece 10 heated from the whole region in the circumferential direction.

According to the thermal load testing device 1 and the thermal load testing method S1 such as described above, it is possible to cause compressed air to flow from the compressor 31 through the hollow portion 11 of the test piece 10 in the cooling fluid supplying step S3, and heat the test piece 10 across the whole region in the circumferential direction using the infrared image furnace 4 in the infrared heating step S4. As a result, it is possible to heat the surface of the test piece 10 using the infrared lamps 42 with the interior of the test piece 10 cooled by the compressed air, and produce a large temperature differential of several hundred degrees between the surface and the interior of the test piece 10 coated with TBC.

In particular, according to the infrared image furnace 4, it is possible to heat the test piece 10 using the infrared lamps 42 uniformly and to a high temperature across an extensive range in the circumferential direction. As a result, the surface of the test piece 10 is heated across the whole region in the circumferential direction by the infrared lamps 42 while compressed air is caused to flow through the hollow portion 11 formed in the center of the test piece 10 so as to cool the test piece 10 from the interior, thereby making it possible to uniformly produce a temperature differential between the surface and the interior of the test piece 10 across the circumferential direction.

Then, by applying a load to the test piece 10 in the axial line O direction using the load applying portion 2 in the load applying step S2 while uniformly producing a large temperature differential in the test piece 10, it is possible to superimpose a load with a large heat flux produced on the test piece 10. As a result, a large temperature differential is produced between the surface and the interior of the test piece 10 coated with TBC while a load is applied to the test piece 10, making it possible to form a temperature field which is uniform in the circumferential direction and has a large heat flux.

This makes it possible to implement a heat cycle test on the test piece 10 coated with TBC under a test environment that superimposes a high heat flux and a load close to those of actual equipment.

Further, by using the infrared image furnace 4, it is possible to finely adjust the heating rate per unit time and heat the test piece 10, unlike a heating device that momentarily applies heat, such as a burner or plasma based device. This makes it possible to suppress the sudden heating of only the surface of the test piece 10 and the load being applied with the interior of the test piece 10 inadequately heated.

Further, by using the infrared image furnace 4, it is possible to surround and heat the test piece 10 with the infrared lamps 42 from the whole region in the circumferential direction, and suppress variation in a temperature distribution in the cross section orthogonal to the axial line O, which causes asymmetrical heating of the test piece 10. As a result, when a load is applied in the axial line O direction, it is possible to suppress a maximum stress in an unsteady field, and thus evaluate the test piece 10.

Further, in the temperature measuring step S5, the temperature of the interior of the test piece 10 is measured by the internal measuring portion 51, and the temperature of the surface of the test piece 10 is measured by the external measuring portion 52. Furthermore, in the synchronizing step S6, the amount of heat applied to the test piece 10 by the synchronizing portion 61 of the controller 6 is adjusted and controlled on the basis of these measurement results. As a result, it is possible to heat the test piece 10 in accordance with the temperature conditions of the surface and the interior of the test piece 10. In particular, the infrared image furnace 4 is capable of responding to changes in input to the infrared image furnace 42 and changing the heating temperature in a short period of time, making it possible to finely adjust the heating rate per unit time. This makes it possible to change the temperature condition of the test piece 10 to a desired state in a short period of time. As a result, this suppresses the implementation of a test in which load is applied to the test piece 10 having an unintended temperature condition, such as only the surface of the test piece 10 being heated and the interior of the test piece 10 being inadequately heated, which makes it possible to efficiently implement a test.

Further, the change amounts of the amount of heat and the load applied to the test piece 10 are synchronized on the basis of the measurement results by the synchronizing portion 61 in the synchronizing step S6, making it possible to synchronize and adjust the change rate of the amount of heat and the change rate of the load in accordance with the temperature condition of the test piece 10. This makes it possible to superimpose an intended load while adjusting the temperature condition of the test piece 10. As a result, the test can be implemented more efficiently.

Further, by using the infrared image furnace 4, it is possible to heat the test piece 10 to a high temperature of several hundred degrees while making the heating device small in size. This makes it easier to support both end sections of the test piece 10 using a hydraulic servo or the like, the both end sections being heated and being subject to an overload, without making the configuration of the device large in scale.

While embodiments of the present invention have been described above with reference to the drawings, each configuration of the embodiments, the combinations thereof, and the like are exemplary, and additions, omissions, substitutions, and other modifications can be made without departing from the spirit of the present invention. Further, the present invention is not to be considered as being limited by the embodiments, and is only limited by the scope of the appended claims.

It should be noted that the shape of the test piece 10 is not limited to a cylindrical shape in which both end sections have diameters that differ from that of the center section as in the present embodiment. The test piece 10 can be formed into any shape in accordance with the conditions of the test to be implemented, as long as the test piece 10 is formed into a tubular shape that includes the hollow portion 11 therein. For example, the test piece 10 may be formed into a cylindrical shape having the same diameter across the whole region in the axial line O direction, or into a rectangular tube shape.

Further, the change rate of the amount of heat applied by the infrared image furnace 4 is not limited to a value obtained by simply adjusting the power supplied to the infrared lamps 42 as in the present embodiment. For example, the power supplied to the infrared lamps 42 may be adjusted upon adjusting conditions such as a temperature or a flow rate of the cooling fluid supplied by the cooling fluid supplying portion 3.

### REFERENCE SIGNS LIST

1 Thermal load testing device
10 Test piece
O Axial line
11 Hollow portion
2 Load applying portion
3 Cooling fluid supplying portion
31 Compressor
32 Valve portion
4 Infrared image furnace
41 Image furnace main body
411 Main portion
411a Interior space
411b Lock portion
411c Observation opening portion
411d Cover portion
412 Reflecting portion
413 Sealing portion
42 Infrared lamp
43 Furnace cooling portion
431 Circulation pipe portion
432 Circulating portion
5 Temperature measuring portion
51 Internal measuring portion
52 External measuring portion
6 Controller
61 Synchronizing portion
62 Load adjusting portion
63 Heat amount adjusting portion
S1 Thermal load testing method
S2 Load applying step
S3 Cooling fluid supplying step
S4 Infrared heating step
S5 Temperature measuring step
S6 Synchronizing step

1. A thermal load testing device comprising:
a load applying portion that applies a load to a tubular test piece in an axial line direction, the tubular test piece having a hollow portion that extends along the axial line;
a cooling fluid supplying portion that causes a cooling fluid to flow through the hollow portion; and
an infrared image furnace that heats the test piece by a plurality of infrared sources disposed so as to surround the test piece from a whole region in a circumferential direction.

2. The thermal load testing device according to claim 1, further comprising:
a temperature measuring portion that measures a temperature of the test piece; and
a controller that adjusts and controls an amount of heat applied to the test piece by the infrared image furnace.

3. The thermal load testing device according to claim 2, wherein
the controller synchronizes a change rate of the amount of heat applied by the infrared image furnace and a change rate of the load applied by the load applying portion on the basis of measurement results from the temperature measuring portion.

4. A thermal load testing method comprising:
a load applying step of applying a load to a tubular test piece in an axial line direction, the tubular test piece having a hollow portion that extends along the axial line;
a cooling fluid supplying step of causing a cooling fluid to flow through the hollow portion, the cooling fluid supplying step being implemented along with the load applying step; and
an infrared heating step of heating the test piece by a plurality of infrared sources disposed so as to surround the test piece from a whole region in a circumferential direction using an infrared image furnace, the infrared heating step being implemented along with the cooling fluid supplying step.

5. The thermal load testing method according to claim 4, further comprising:
a temperature measuring step of measuring temperatures of the test piece, and
a synchronizing step of synchronizing a change rate of an amount of heat applied to the test piece and a change rate of a load applied to the test piece on the basis of the temperatures of the test piece measured in the temperature measuring step.
